(19) United States
(12) Patent Application Publication
(10) Pub. No.: US 2025/0289335 A1
(43) Pub. Date: Sep. 18, 2025

(54) MEASURING UNIT AND CHARGING DEVICE

(71) Applicant: Siemens Aktiengesellschaft, München (DE)

(72) Inventors: Claus Seisenberger, Neufrannhofen (DE); Martin Kullmann, Nürnberg (DE)

(21) Appl. No.: 18/860,227

(22) PCT Filed: Apr. 29, 2022
(86) PCT No.: PCT/EP2022/061539

§ 371 Date: Oct. 25, 2024

(51) Int. Cl. B60L 53/38; B60L 53/122; G01B 7/00; H02J 50/10; H02J 50/90

(52) U.S. Cl. CPC B60L 53/38; B60L 53/122; G01B 7/003; H02J 50/10; H02J 50/90

(57) ABSTRACT

A measuring unit is provided, including at least one first primary positioning sensor and a connector for use in positioning a primary coil of a charging unit and a secondary coil of an electric vehicle. The measuring unit is designed in such a way that it can be fixedly connected to the charging unit by the connector, and the at least one first primary positioning sensor is designed to communicate wirelessly with at least one secondary positioning sensor of the electric vehicle during the positioning process. A charging device including a measuring unit and a charging unit is also provided.

### CROSS-REFERENCE TO RELATED APPLICATIONS

This application is a national stage of PCT Application No. PCT/EP2022/061539, having a filing date of Apr. 29, 2022, the entire contents of which are hereby incorporated by reference.

### FIELD OF TECHNOLOGY

The following relates to a measuring unit and a charging device.

### BACKGROUND

Electric vehicles can be charged inductively with electrical energy. For this purpose, the electric vehicle comprises a secondary coil that can be inductively coupled with a primary coil of a charging station. The primary coil is usually located in the base of a charging station so that the electric vehicle with the secondary coil can be positioned above the primary coil. Ideally, the secondary coil is located on the underbody of the electric vehicle, in particular in the area of the front axle. For inductive charging, the primary and secondary coils must be positioned as precisely as possible one above the other. The positioning tolerance is a few centimeters in the direction of travel of the electric vehicle and in the direction perpendicular to it and parallel to the ground. The maximum angle of rotation around the vertical axis is only a few degrees. It is therefore difficult to position the electric vehicle appropriately for inductive charging.

On the one hand, a method for determining a position of the electric vehicle relative to the charging station is helpful in order to support a driver of the electric vehicle when traveling to a position suitable for inductive charging of the electric vehicle. On the other hand, determining the position of the electric vehicle relative to the charging station is also relevant to safety, because a charging release, i.e., permission to activate the charging field of the primary coil, can only be given if the secondary coil is within a defined tolerance range above the primary coil. In addition, an optimum energy flow is only guaranteed if the primary and secondary coils are optimally aligned with each other.

To determine the position of the electric vehicle relative to the charging station, it is known to transmit an alternating magnetic field by a transmitter positioned on the electric vehicle, which is received at the location of the charging station and can be used to draw conclusions about the position, see for example US 2016/0089997 A1. However, the reliability and accuracy of determining the position are not yet satisfactory.

### SUMMARY

An aspect relates to a measuring unit and a charging device, each of which can be used to improve the positioning of a primary coil of a charging unit with a secondary coil of an electric vehicle.

Embodiments of the invention relate to a measuring unit with at least one first primary positioning sensor and a connector for use for positioning a primary coil of a charging unit and a secondary coil of an electric vehicle, in which the measuring unit is designed in such a way that it can be firmly connected to the charging unit by the connector and the at least one first primary positioning sensor is designed to communicate wirelessly with at least one secondary positioning sensor of the electric vehicle during positioning.

This measuring unit has the advantage that it is positioned locally offset from the primary coil, thereby enabling the primary coil to be positioned in relation to the secondary coil in a reliable manner. For example, electromagnetic waves used for positioning are not disturbed by the primary coil, or only to a small extent, due to the locally offset position of the at least one first primary positioning sensor. The fixed connection of the measuring unit to the charging unit by the connector ensures that the local position of the at least one first primary positioning sensor relative to the primary coil is not changed even in the event of external influences, such as vandalism or displacement of the charging unit, so that positioning can be executed extremely reliably and accurately even in the event of external influences.

The term “fixedly connectable” is understood to mean that the measuring unit and the charging unit can be fixedly connected to each other via the connector, for example by a screw connection, by plugging together and/or by bonding. This term can also be understood to mean that, once a connection has been established between the charging unit and the measuring unit, both units are inseparably connected to each other. In addition, this term is used to express the fact that the connection fixedly defines a local position of the charging unit with respect to the measuring unit or of the primary coil with respect to the at least one primary positioning sensor, which means that the local position remains virtually unchanged even in the event of external influences, such as displacement of the charging unit. “Virtually” means that a change in the distance between a center of the at least one first primary positioning sensor and the center of the primary coil is very small, e.g., a change of 0.2 cm is small compared to the distance of 100 cm before the displacement and thus the local position is virtually unchanged. This property is important so that the position of the secondary coil in relation to the primary coil, i.e., the positioning, can be determined with sufficient accuracy, for example to within a few millimeters.

In the context of the application, the term “communicate” is understood to mean that a respective primary positioning sensor can wirelessly transmit information as a transmitter, which can be received by a respective secondary positioning sensor and can be used to position the primary coil relative to the secondary coil. Alternatively, a respective secondary positioning sensor can also serve as a transmitter and a respective primary positioning sensor as a receiver. The communication can be uni-directional or bi-directional. The information can be coded and transmitted in the form of electromagnetic waves. The information can also be encoded and transmitted using WLAN (WLAN—Wireless Local LAN) and an IP protocol (IP—Internet Protocol) with a PTP in accordance with IEEE1588 (PTP—Precision Time Protocol).

In a development, the measuring unit is elongated, with the connector being positioned on a first side of the measuring unit and the first primary positioning sensor being positioned on a second side of the measuring unit opposite the first side. The elongated design of the measuring unit means that there is a greater distance between the primary coil and the at least one first positioning sensor, whereby interference from the coil, for example from its windings, is reduced or avoided during positioning. The elongated design also has the advantage that the measuring unit can be prevented from being run over by the electric vehicle if the elongated shape of the measuring unit is selected in the direction of travel of the electric vehicle. The elongated design of the measuring unit can therefore also ensure that the measuring unit is robust in practical use.

In a development, the measuring unit is at least partially formed as a tube, in particular at least partially with a rectangular or round cross section. The design of the measuring unit as a tube is advantageous because it allows the measuring unit to be manufactured and provided in a simple and cost-effective manner using standard components. An internally hollow tube has the advantage that a power supply cable and/or wires for transmitting signals from the at least one first primary positioning sensor are routed in an orderly fashion inside the tube and are also protected from damage, such as when driven over by the electric vehicle. A rectangular cross section is advantageous because it provides the measuring unit with a smooth side that can lie flat on a surface underneath and can be used to give the measuring unit additional stability against slipping or shifting relative to the ground. A round cross section of the tube is also advantageous because it provides a high degree of protection against damage in the event of the tube being driven over by the electric vehicle, even if the tube is made of thin material. In an alternative development, the tube can also have a cross section such that it is round except for one point on its circumference and is flat at the point. This special development can ensure that the round part of the tube provides particularly good protection against damage and that the flat part of the tube, when resting on the ground, provides good protection against the tube slipping or shifting. The tube can also be designed in one or more parts. For example, the tube is designed in two parts, where a first part, which is flat, lies at least partially on the ground and can be fixed to the ground, in particular by fasteners such as screws, and a second part of the tube is shaped as an arch and can be connected to the first part by a locking mechanism, for example by a snap connection with snap hooks. The tube may be hollow or filled on the inside. Furthermore, the tube may also have fasteners for connecting it to a cable of the charging unit, for example the tube has eyelets through which a cable tie is passed that is pulled around the cable.

In a development of the measuring unit, a cable for supplying power to the primary coil is integrated into the tube. This development allows the measuring unit to ensure protection against damage to the cable. Furthermore, the measuring unit ensures that the cable is guided in a fixed, predetermined position, which can reduce potential damage to the cable from being run over.

In a development, at least one of the first primary positioning sensors can receive electrical energy for its operation by an electrical connection to the cable. This provides a more cost-effective solution than using dedicated wiring.

In a development, the measuring unit is Y-shaped or T-shaped, has the connector at one end of the Y/T and a respective first primary positioning sensor is positioned at a respective other end of the Y/T. This development enables cost-effective and reliable positioning when using two first primary positioning sensors. Furthermore, the specific geometric shape of the Y/T can provide additional protection against slipping or displacement of the measuring unit if it lies almost flat on the ground.

In a development, the charging unit has a cable for power supply or signal exchange, which is led out of a housing of the charging unit, wherein the connector is designed in such a way that the at least one first primary positioning sensor can be fixedly connected to the cable. This development has the advantage that the first primary positioning sensor can be fixedly connected to the charging unit via its cable with little effort and/or at very low cost. With a charging unit output of 22 kW, for example, a diameter of the cable is several centimeters thick and therefore not very flexible. Even if the charging unit and cable are moved, a local position of the first primary sensor changes only slightly—if at all—so that positioning can be of a sufficiently high standard after moving. In this development, the first primary positioning sensor can be supplied with electrical energy by its own battery, for example. The connection can be realized by clamping, screwing, plugging or gluing the at least one first primary positioning sensor. The connector can be realized, for example, by a clamp, a screw, a pin, a clip, a Velcro strap, adhesive tape or adhesive.

Embodiments of the invention further relate to a charging device for inductively charging an electric vehicle, comprising the charging unit and the measuring unit according to one of the preceding embodiments, in which the charging unit further comprises, in addition to the primary coil, at least one second primary positioning sensor which performs the positioning together with the at least one first primary positioning sensor and the at least one secondary positioning sensor of the electric vehicle.

This development makes it possible to improve the positioning accuracy. This is based, among other things, on the fact that the second primary positioning sensors also have a fixed local position relative to the primary coil, so that a joint measurement evaluation of measurement signals from the first primary positioning sensors and the second primary positioning sensors achieves accuracy in determining the position of the primary coil relative to the secondary coil.

In a development of the charging device, at least one of the second primary positioning sensors is positioned in the charging unit in such a way that a distance between the primary coil and the at least one first primary positioning sensor is smaller than a distance between the second primary positioning sensor and the at least one first primary positioning sensor. The second primary positioning sensor could, in principle, be positioned at any point in or on or at the charging unit. To improve positioning, a distance between the primary sensors should be as large as possible. This development makes it possible for a distance between the at least one second primary positioning sensor and the first primary positioning sensor to be greater than the distance between the first primary positioning sensor and the primary coil. This improves the positioning accuracy by the charging device.

In a development of the charging device, the at least one first primary positioning sensor and the two second primary positioning sensors are positioned in such a way that these sensors span an isosceles triangle with a base formed by a distance between the two second primary positioning sensors. This development further improves the positioning, since the selected geometric arrangement of the sensors ensures that a distance between the first primary sensor and a respective second primary sensor is the same, in particular is maximized in a specific configuration of the measuring unit and the charging unit.

In addition, the charging device possesses the same advantages mentioned for the measuring unit. In the context of the application, a distance between a coil and/or one or more of the positioning sensors can be considered. This can be understood in such a way that the respective distance from/to a center of the respective positioning sensor or from/to a center of the respective coil is determined.

### BRIEF DESCRIPTION

Some of the embodiments will be described in detail, with reference to the following figures, wherein like designations denote like members, wherein:

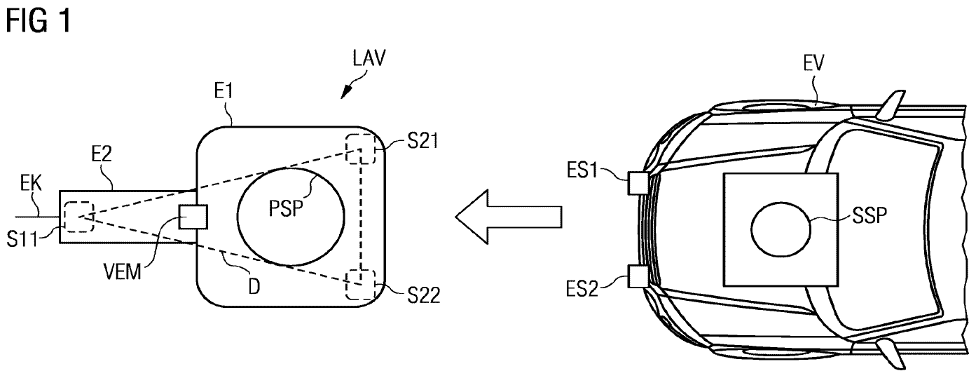

FIG. 1 shows a charging device with a measuring unit and a charging unit;

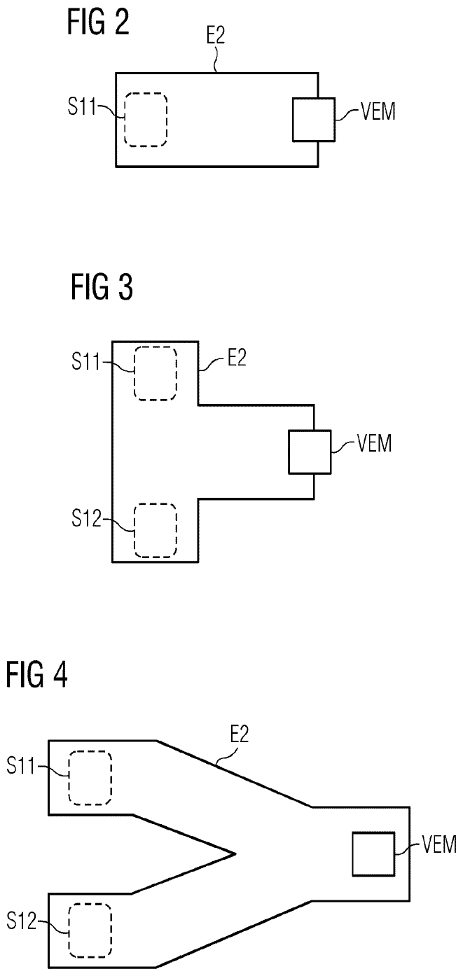

FIG. 2 shows a measuring unit;

FIG. 3 shows an alternative embodiment of a measuring unit;

FIG. 4 shows an additional alternative embodiment of a measuring unit; and

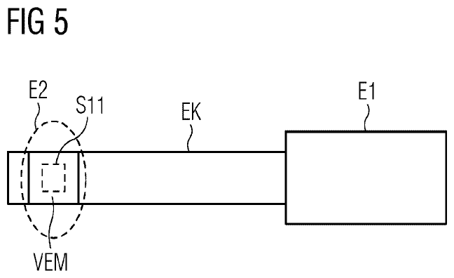

FIG. 5 shows an optional embodiment of a measuring unit

### DETAILED DESCRIPTION

FIG. 1 shows a charging device LAV according to an exemplary embodiment of the invention, toward which an electric vehicle EV drives, see arrow, in order to be able to inductively charge a battery of the electric vehicle. This charging device has a charging unit E1, which has a primary coil PSP for transferring energy to a secondary coil SSP of an electric vehicle EV. The primary coil can have several windings/layers. The first unit may cover an area of 50 cm×50 cm on the ground and have a height of 10 cm.

The charging device LAV also has a measuring unit E2. In FIG. 1, this is designed as a cable duct with a square cross section, in which an electric cable EK is routed to the charging unit E1 and supplies the primary coil with electrical energy. This electrical energy is then applied via a magnetic flux to a secondary coil SPS of the electric vehicle to charge the battery of the electric vehicle.

The measuring unit has a connector VEM that is suitable for fixedly connecting the measuring unit E2 to the charging unit E1, for example in the form of a screw or snap connection. Furthermore, the measuring unit has a first primary positioning sensor S11 near one end of the cable duct, opposite the connector. In practice, the first primary positioning sensor can be positioned 0 to 10 cm from the end of the measuring unit.

In addition to the first primary positioning sensor S11, the charging unit features second primary positioning sensors S21, S22. The primary positioning sensors can be positioned such that they form an isosceles triangle D with the primary positioning sensors at the triangle edges, with a distance between the two second primary positioning sensors S21, S22 forming the base of the triangle. The triangle D is shown as a dashed line in FIG. 1.

The primary positioning sensors S11, S12, S21, S22 are designed to communicate wirelessly with secondary positioning sensors ES1, ES2 installed in the electric vehicle. As an example, the primary positioning sensors are designed as transmitters that emit electromagnetic waves at a frequency of 125 kHz. These electromagnetic waves are received by the secondary positioning sensors and a position of the secondary coil of the electric vehicle relative to the primary coil of the charging device is determined after analyzing one or more measurement signals, e.g., by duration measurements, a measurement of field strength and field direction of the electromagnetic signal or field direction of the magnetic waves. This is referred to as positioning, which is based, for example, on triangulation or a field model of the electromagnetic signal. This can be used to automatically guide or move the electric vehicle in such a way that the primary coil and the secondary coil can be positioned above each other in such a way that it is possible to have a magnetic flux with low losses after positioning is complete.

The position can be determined particularly well if the second primary positioning sensor is positioned in the second unit in such a way that it is not located below the electric vehicle, at least until the positioning of the primary coil and the secondary coil has been completed. For example, a center of the secondary coil is positioned 80 cm from the outside of the body of the electric vehicle, for example the bumper. Thus, with a distance of greater than 80 cm between the first primary positioning sensor and the center of the primary coil SPS, it is possible to achieve a situation where the electromagnetic signal of the first primary positioning sensor is hardly or not at all disturbed by the vehicle.

Due to the fixed, i.e., fixed mechanical, connection of the measuring unit E1 to the charging unit E2 and a defined local position of the primary sensors, the positioning can be very precise, as even external influences on the measuring unit and/or charging unit do not change the local position of the measuring unit in relation to the local position of the charging unit, as there is a fixed connection between the measuring unit and the charging unit.

In the exemplary embodiment shown in FIG. 1, the primary positioning sensors are designed as transmitters and the secondary positioning sensors are designed as receivers. Alternatively, the primary positioning sensors can be designed as receivers and the secondary positioning sensors as transmitters or a mixture thereof. The sensors can communicate using electromagnetic signals, such as UWB (ultra wideband) or in the LF (low frequency) range.

In addition to a single first primary positioning sensor, the measuring unit can have two or more first primary positioning sensors. The respective first primary positioning sensor can be integrated into the body of the measuring unit to protect it from contamination or damage and/or can be attached to an outer side of the body of the measuring unit. Since the charging device can lie on a surface, the first primary positioning sensor or sensors is/are not positioned on a side of the measuring unit facing the surface, but on a side of the measuring unit opposite the surface.

FIG. 2 shows the measuring unit E2 with the connector VEM designed as a plug-in device and a first primary positioning sensor S11. In this example, a body of the measuring unit is made of hard plastic in the form of a tube with an outer diameter of approximately 5 cm and an inner diameter of approximately 3 cm. The first primary sensor S11 can be connected to the charging unit E1 for power supply via a cable (positioned inside the measuring unit in FIG. 2 and therefore not shown graphically).

FIG. 3 shows an alternative position of the measuring unit E2 in the form of a “T”. The connector VEM is positioned at the base of the “T” and a first primary positioning sensor S11, S12 is positioned at each of the two outer points of the “T”.

FIG. 4 shows an additional alternative position of the measuring unit E2 in the form of a “Y”. The connector VEM is positioned at the base of the “Y” and a first primary positioning sensor S11, S12 is positioned at each of the two outer points of the “Y”.

FIG. 5 shows another example of an optimized design of the measuring unit E2. Here, a power supply cable EK is fixedly connected to the charging unit ED1. The at least one first primary positioning sensor is fixedly connected to a cable tie. The cable tie realizes the connector in such a way that the cable tie is guided around the cable EK and then pressed firmly against the cable by the closure element associated with the cable tie. In this exemplary embodiment, the second measuring unit is attached at a distance of 50 cm to 100 cm from the charging unit, for example. It is advantageous that the specific local position of the first primary positioning sensor S11 can be adapted to the electric vehicle. This first primary positioning sensor can be positioned in such a way that the first primary positioning sensor does not come to rest under the electric vehicle if the primary coil and the secondary coil overlap.

The measuring unit can be used with charging units and/or charging devices that, for example, provide electric vehicles for transporting people or goods. The electric vehicles can be controlled by a person or autonomously. The electric vehicle can be designed as a transport robot in a factory or as a cleaning robot in a hospital.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A measuring unit comprising:
at least one first primary positioning sensor; and
a connector for use for positioning a primary coil of a charging unit and a secondary coil of an electric vehicle,
wherein the measuring unit is configured in such a way that the measuring unit can be fixedly connected to the charging unit by the connector and the at least one first primary positioning sensor is configured to communicate wirelessly with at least one secondary positioning sensor of the electric vehicle during positioning.

2. The measuring unit as claimed in claim 1, wherein the measuring unit is elongated, the connector is positioned on a first side of the measuring unit and the at least one first primary positioning sensor is positioned on a second side of the measuring unit opposite the first side.

3. The measuring unit as claimed in claim 1, wherein the measuring unit is configured at least partially as a tube, at least partially with a rectangular or round cross section.

4. The measuring unit as claimed in claim 3, wherein a cable for supplying power to the primary coil is integrated into the tube.

5. The measuring unit as claimed in claim 4, wherein at least one of the first primary positioning sensors receives electrical energy for operation by an electrical connection to the cable.

6. The measuring unit as claimed in claim 1, wherein the measuring unit is Y-shaped or T-shaped, has the connector at one end of the Y/T and a respective first primary positioning sensor is positioned at a respective other end of the Y/T.

7. The measuring unit as claimed in claim 1, wherein
the charging unit has a cable for power supply or for signal exchange,
which is routed out of a housing of the charging unit; and
the connector is configured in such a way that the at least one first primary positioning sensor can be fixedly connected to the cable, by clamping, screwing, plugging, or gluing.

8. A charging device for inductively charging an electric vehicle, comprising the charging unit and the measuring unit as claimed in claim 1, wherein the charging unit further comprises at least one second primary positioning sensor which performs the positioning together with the at least one first primary positioning sensor and the at least one secondary positioning sensor of the electric vehicle.

9. The charging device as claimed in claim 8, wherein at least one of the second primary positioning sensors is positioned in the charging unit such that a distance between the primary coil and the at least one first primary positioning sensor is smaller than a distance between the second primary positioning sensor and the at least one first primary positioning sensor.

10. The charging device as claimed in claim 7, wherein the at least one first primary positioning sensor and the two second primary positioning sensors are positioned such that sensors span an isosceles triangle with a base formed by a distance between the two second primary positioning sensors.
